(19) United States
(12) Patent Application Publication
(10) Pub. No.: US 2022/0289395 A1
(43) Pub. Date: Sep. 15, 2022

(54) PROPULSION SYSTEM FOR AIRCRAFT AND METHOD OF MANUFACTURING AIRCRAFT

(71) Applicant: HONDA MOTOR CO., LTD., Tokyo (JP)

(72) Inventors: Takeshi Matsumoto, Wako-shi (JP); Akinori Kita, Wako-shi (JP)

(21) Appl. No.: 17/674,873

(22) Filed: Feb. 18, 2022

(30) Foreign Application Priority Data
Mar. 9, 2021 (JP) 2021-036959
Mar. 9, 2021 (JP) 2021-037401

(51) Int. Cl. B64D 27/24; B64C 27/08; B64D 31/06; B60L 50/16; B60L 50/61; B60L 15/20

(52) U.S. Cl. CPC B64D 27/24; B64C 27/08; B64D 31/06; B60L 50/16; B60L 50/61; B60L 15/2045; B64D 2221/00; B64D 2027/026

(57) ABSTRACT

In a propulsion system for an aircraft, when a flight state of the aircraft is a first state in which the aircraft is cruising, power is supplied to an electric motor from only a high-capacity storage battery. When the flight state of the aircraft is a second state in which the aircraft is taking off or landing, power is supplied to the electric motor from only an output type storage battery when a charge amount of the output type storage battery is equal to or greater than a first threshold, and power is supplied to the electric motor from the output type storage battery and the high-capacity storage battery when the charge amount of the output type storage battery is smaller than the first threshold.

### CROSS-REFERENCE TO RELATED APPLICATION

Priority is claimed on Japanese Patent Application No. 2021-036959 filed Mar. 9, 2021 and No. 2021-037401 filed Mar. 9, 2021, the content of both of which is incorporated herein by reference.

### BACKGROUND OF THE INVENTION

### Field of the Invention

The present invention relates to a propulsion system for an aircraft and a method of manufacturing an aircraft.

### Description of Related Art

In the related art, a propulsion system for an aircraft in which a plurality of engines are attached to an aircraft main body and a generator is connected to the engines is known (for example, refer to Cited Document 1 (Japanese Unexamined Patent Application, First Publication No. 2016-88110)).

This propulsion system for an aircraft has a main battery and the generator for supplying power to an electric motor and charges the main battery with power converted from dynamic power of the engines driving the generator when a residual quantity of the main battery becomes smaller than a threshold.

### SUMMARY OF THE INVENTION

### Technical Problem

However, in the propulsion system for an aircraft in the related art, in addition to power supplied from a storage battery used during normal flight, there is a need to mount a storage battery for supplying power used when an abnormality occurs, and this may cause increase in capacity of the storage battery, increase in quantity of heat generation, and increase in size of a cooling system for curbing generation of heat. As a result, the foregoing increases lead to an increase in weight of the propulsion system and lead to decrease in payload of an airframe.

The present invention has been made in consideration of such circumstances, and an object thereof is to provide a propulsion system for an aircraft, in which the capacity and the weight of a mounted storage battery can be reduced, and a method of manufacturing an aircraft.

### Solution to Problem

A propulsion system for an aircraft and a method of manufacturing an aircraft according to this invention employ the following constitutions.

(1): A propulsion system for an aircraft according to an aspect of the present invention is mounted in an airframe of an aircraft and includes a first storage battery, a second storage battery that has a smaller capacity and more power able to be output per hour than the first storage battery, a charge amount determination unit that determines at least a state of charge in the second storage battery, an electric motor that is driven by means of power supplied from the first storage battery or the second storage battery, a rotor that is driven by means of a driving force output by the electric motor, and a control unit that controls power supplied from the first storage battery or the second storage battery to the electric motor by controlling a connection unit connecting the first storage battery or the second storage battery and the electric motor to each other. The control unit controls the connection unit such that power is exclusively supplied from the first storage battery to the electric motor when a flight state of the aircraft is a first state, controls the connection unit such that power is exclusively supplied from the second storage battery to the electric motor when the flight state of the aircraft is a second state having a larger altitude variation than the first state and the state of charge in the second storage battery is a state having a degree of charge higher than a first reference, and controls the connection unit such that power is supplied from both the first storage battery and the second storage battery to the electric motor when the flight state of the aircraft is the second state and the state of charge in the second storage battery is a state having a degree of charge lower than the first reference.

(2): According to the aspect (1), the propulsion system for an aircraft may further include an engine that is attached to the airframe of the aircraft, and a generator that is connected to an engine shaft of the engine. The first storage battery and the second storage battery may store power generated by the generator. The electric motor may be driven by means of power supplied from the first storage battery, the second storage battery, or the generator.

(3): According to the aspect (1) or (2), the control unit may control the connection unit such that supply of power from the second storage battery to the electric motor is stopped when the state of charge in the second storage battery is a state having a degree of charge lower than a second reference. The second reference may be a reference indicating a lower charging rate or a lower charge amount than the first reference.

(4): According to the aspect (2), the control unit may control the connection unit such that power generated by the generator is supplied to the second storage battery when the state of charge in the second storage battery is a state having a degree of charge lower than the second reference. The second reference may be a reference indicating a lower charging rate or a lower charge amount than the first reference.

(5): According to the aspect (1), the control unit may control the connection unit such that power is exclusively supplied from the second storage battery to the electric motor when the flight state is a third state and the state of charge in the second storage battery is a state having a degree of charge higher than a third reference, may control the connection unit such that power is supplied from both the first storage battery and the second storage battery to the electric motor when the flight state is the third state and the state of charge in the second storage battery has a degree of charge lower than the third reference and has a degree of charge higher than a fourth reference, and may control the connection unit such that power is exclusively supplied from the first storage battery to the electric motor when the flight state is the third state and when the state of charge in the second storage battery has a degree of charge lower than the fourth reference. The third state may be a state having a larger altitude variation than the first state and having a smaller altitude variation than the second state.

(6): A propulsion system for an aircraft according to another aspect of the present invention is mounted in an airframe of an aircraft and includes an engine that is attached to the airframe of the aircraft; a generator that is connected to an engine shaft of the engine; a first storage battery; a second storage battery that has a smaller capacity and more power able to be output per hour than the first storage battery; an electric motor that is driven by means of power supplied from the first storage battery, the second storage battery, or the generator; a rotor that is driven by means of a driving force output by the electric motor; and a control unit that controls power supplied from the first storage battery or the second storage battery to the electric motor by controlling a connection unit connecting the first storage battery or the second storage battery and the electric motor to each other. The control unit controls the connection unit such that power is supplied from the second storage battery to the electric motor when the generator or the first storage battery has malfunctioned.

(7): A propulsion system for an aircraft according to another aspect of the present invention includes an engine that is attached to an airframe of the aircraft, a generator that is connected to an engine shaft of the engine, a storage battery that is charged with power generated by the generator, a charge amount determination unit that determines a state of charge in the storage battery, an electric motor that is driven by means of power supplied from the generator and the storage battery, a rotor that is driven by means of a driving force output by the electric motor, and a control unit that controls power supplied from the storage battery to the electric motor by controlling a connection unit connecting the storage battery and the electric motor to each other. When a flight state of the aircraft changes from a first state to a third state via a second state, the control unit sets a charge amount of the storage battery before the first state such that the state of charge in the storage battery at a point of time when the first state ends is within a first charging range, controls the connection unit such that power is exclusively supplied from the storage battery to the electric motor while the flight state is the first state, controls the connection unit such that power is exclusively supplied from the generator to the electric motor while the flight state is the second state, controls the connection unit such that power generated by the generator is supplied to the storage battery such that the charge amount of the storage battery at a point of time when the third state ends is within a second charging range while the flight state is the second state, and controls the connection unit such that power is exclusively supplied from the storage battery to the electric motor while the flight state is the third state. The second state is a state having a smaller altitude variation than the first state and the third state.

(8): A propulsion system for an aircraft according to another aspect of the present invention includes an engine that is attached to an airframe of the aircraft, a generator that is connected to an engine shaft of the engine, a storage battery that is charged with power generated by the generator, a charge amount determination unit that determines a state of charge in the storage battery, an electric motor that is driven by means of power supplied from the generator and the storage battery, a rotor that is driven by means of a driving force output by the electric motor, and a control unit that controls power supplied from the storage battery to the electric motor by controlling a connection unit connecting the storage battery and the electric motor to each other. When a flight state of the aircraft changes from a first state to a third state via a second state, the control unit sets a charge amount of the storage battery before the first state such that the state of charge in the storage battery at a point of time when the first state ends is within a first charging range, controls the connection unit such that power is supplied from the generator and the storage battery to the electric motor while the flight state is the first state, controls the connection unit such that power is exclusively supplied from the generator to the electric motor while the flight state is the second state, controls the connection unit such that power generated by the generator is supplied to the storage battery such that the charge amount of the storage battery at a point of time when the third state ends is within a second charging range while the flight state is the second state, and controls the connection unit such that power is supplied from the generator and the storage battery to the electric motor while the flight state is the third state. The second state is a state having a smaller altitude variation than the first state and the third state.

(9): According to the aspect (7) or (8), a lower limit for both the first charging range and the second charging range may be zero.

(10): According to the aspects (7) to (9), before the aircraft takes off, the storage battery may be charged with power supplied from a ground external power source or power generated by the generator up to the set charge amount.

(11): A propulsion system for an aircraft according to another aspect of the present invention includes an engine that is attached to an airframe of the aircraft, a generator that is connected to an engine shaft of the engine, a storage battery that is charged with power generated by the generator, a charge amount determination unit that determines a state of charge in the storage battery, an electric motor that is driven by means of power supplied from the generator and the storage battery, a rotor that is driven by means of a driving force output by the electric motor, and a control unit that controls power supplied from the storage battery to the electric motor by controlling a connection unit connecting the storage battery and the electric motor to each other. The control unit controls the connection unit such that power is exclusively supplied from the generator to the electric motor when the generator is able to be used, and controls the connection unit such that power is supplied from only the storage battery to the electric motor when the generator is not able to be used. A charge amount of the storage battery is set such that a charge amount equal to or greater than a third threshold is retained when the aircraft lands.

(12): A method of manufacturing an aircraft according to an aspect of the present invention is a method of manufacturing an aircraft using the propulsion system for an aircraft according to the foregoing aspects (1) to (6). The ratio between the numbers of output type storage battery cells and high-capacity storage battery cells mounted in the aircraft is determined based on a state during flight.

### Advantageous Effects of Invention

According to the aspects (1) to (4), the weight of the storage battery can be reduced by using a suitable storage battery in accordance with the first state and the second state.

According to the aspects (3) and (4), reliability of safe landing when the generator or the high-capacity storage battery has malfunctioned can be enhanced. According to the aspect (5), reliability of safe landing when the generator or the high-capacity storage battery has malfunctioned can be enhanced, and a storage battery cooling device for heat generation countermeasures can be reduced in size.

According to the aspects (7) to (10), the weight of the mounted storage battery can be reduced by performing charging during cruising.

According to the aspect (11), the weight of the mounted storage battery can be reduced by supplying power from the storage battery only when the generator has malfunctioned.

### BRIEF DESCRIPTION OF THE DRAWINGS

FIG. 1 is a view schematically showing a flying object in which a propulsion system for an aircraft is mounted.

FIG. 2 is a view showing an example of a functional constitution of the flying object according to a first embodiment.

FIG. 3 is a view showing another example of a functional constitution of the flying object according to the first embodiment.

FIG. 4 is an explanatory view of a flight state of the flying object according to the first embodiment.

FIG. 5 is a flowchart showing an example of a flow of processing executed by a control device according to the first embodiment.

FIG. 6 is a flowchart showing a flow of processing executed by the control device according to the first embodiment when the flight state is a first state.

FIG. 7 is a flowchart showing a flow of processing executed by the control device according to the first embodiment when the flight state is a second state.

FIG. 8 is a flowchart showing an example of a flow of processing executed by the control device according to a second embodiment.

FIG. 9 is an explanatory view of the flight state of the flying object according to a third embodiment.

FIG. 10 is a flowchart showing an example of a flow of processing executed by the control device according to the third embodiment.

FIG. 11 is a flowchart showing a flow of processing executed by the control device when the flight state is the second state.

FIG. 12 is a flowchart showing a method of setting a storage battery mounted in an aircraft.

FIG. 13 is a view showing an example of a functional constitution of a flying object according to a fifth embodiment.

FIG. 14 is an explanatory view of a flight state of the flying object according to the fifth embodiment.

FIG. 15 is a flowchart showing an example of a flow of processing executed by the control device according to the fifth embodiment.

FIG. 16 is a flowchart showing an example of a flow of processing executed by the control device according to a sixth embodiment.

### DETAILED DESCRIPTION OF THE INVENTION

Hereinafter, embodiments of a propulsion system for an aircraft according to the present invention will be described with reference to the drawings.

### First Embodiment

[Overall Constitution]

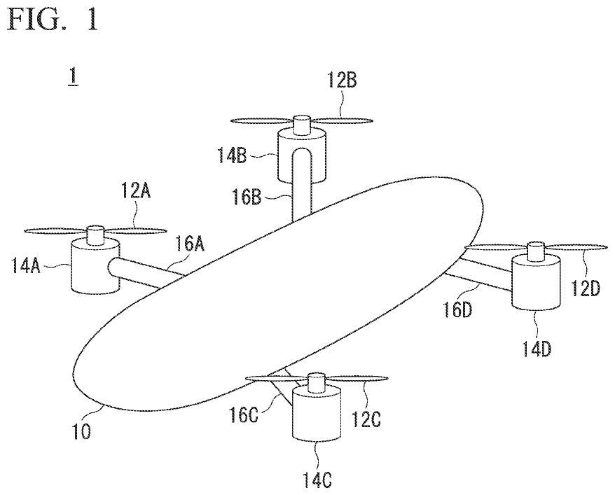

FIG. 1 is a view schematically showing a flying object 1 in which a propulsion system for an aircraft is mounted. For example, the flying object 1 includes an airframe 10, a plurality of rotors 12A to 12D, a plurality of electric motors 14A to 14D, and arms 16A to 16D. Hereinafter, when the plurality of rotors 12A to 12D are not distinguished from each other, they will be referred to as the rotors 12, and when the plurality of electric motors 14A to 14D are not distinguished from each other, they will be referred to as the electric motors 14. The flying object 1 may be a manned flying object or may be an unmanned flying object. The flying object 1 is not limited to the shown multicopter and may be a helicopter or a compound flying object including both a rotor blade and a fixed blade.

The rotor 12A is attached to the airframe 10 via the arm 16A. The electric motor 14A is attached to a base portion (a rotary shaft) of the rotor 12A. The electric motor 14A drives the rotor 12A. For example, the electric motor 14A is a brushless DC motor. The rotor 12A is a fixed blade which is a blade rotating around an axis parallel to a gravity direction when the flying object 1 is in a horizontal posture. Since the rotors 12B to 12D, the arms 16B to 16D, and the electric motors 14B to 14D also have functional constitutions similar to those described above, description thereof will be omitted.

When the rotors 12 rotate in response to a control signal, the flying object 1 flies in a desired flight state. A control signal is a signal for controlling the flying object 1 based on an operation of an operator or an instruction in autopilot. For example, when the rotor 12A and the rotor 12D rotate in a first direction (for example, the clockwise direction) and the rotor 12B and the rotor 12C rotate in a second direction (for example, the counterclockwise direction), the flying object 1 flies. In addition to the foregoing rotors 12, auxiliary rotors for posture holding or for horizontal propulsion (not shown) or the like may be provided.

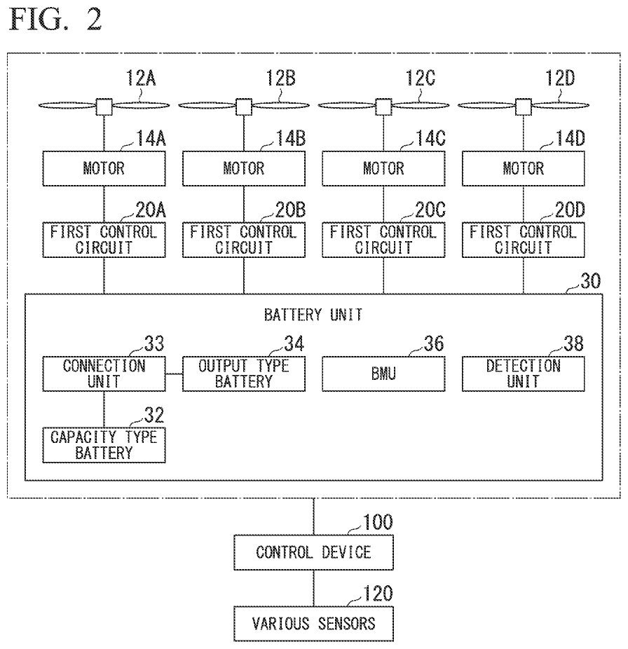

FIG. 2 is a view showing an example of a functional constitution of the flying object 1 according to a first embodiment. For example, in addition to the constitution shown in FIG. 1, the flying object 1 includes first control circuits 20A, 20B, 20C, and 20D and a storage battery unit 30, for example. Hereinafter, when the first control circuits 20A to 20D are not distinguished from each other, they will be referred to as the first control circuits 20.

The first control circuits 20 are power drive units (PDUs) including a drive circuit such as an inverter. The first control circuits 20 supply power obtained by converting power supplied from the storage battery unit 30 through switching or the like to the electric motors 14. The electric motors 14 drive the rotors 12.

For example, the storage battery unit 30 includes a high-capacity storage battery 32, a connection unit 33, an output type storage battery 34, a battery management unit (BMU) 36, and a determination unit 38. For example, the high-capacity storage battery 32 and the output type storage battery 34 are assembled batteries in which a plurality of battery cells are connected in series, in parallel, or in series-parallel. For example, the battery cells constituting the high-capacity storage battery 32 and the output type storage battery 34 are secondary batteries such as lithium-ion batteries (LIB) or nickel-hydride batteries, in which charging and discharging can be repeatedly performed. The high-capacity storage battery 32 is superior to the output type storage battery 34 in having a larger capacity, and the output type storage battery 34 is superior to the high-capacity storage battery 32 in having greater power able to be output per hour.

The connection unit 33 is connected to the high-capacity storage battery 32, the output type storage battery 34, and the first control circuits 20. The connection unit 33 is controlled by a control device 100 such that power is supplied to the first control circuits 20 selectively from one of or both the high-capacity storage battery 32 and the output type storage battery 34. For example, the connection unit 33 includes a DC-DC converter. Therefore, power is exclusively supplied from the high-capacity storage battery 32 to the first control circuits 20 and power is not supplied from the output type storage battery 34 by boosting an output potential of the high-capacity storage battery 32, and power is supplied from the output type storage battery 34 to the first control circuits 20 by curbing boosting. In addition, the connection unit 33 may realize a function similar to that described above using a switch, for example.

The BMU 36 performs cell balancing, determination of an abnormality in the high-capacity storage battery 32 and the output type storage battery 34, derivation of a cell temperature of the high-capacity storage battery 32 and the output type storage battery 34, derivation of a charging/discharging current of the high-capacity storage battery 32 and the output type storage battery 34, estimation of an SOC of the high-capacity storage battery 32 and the output type storage battery 34, and the like. The determination unit 38 is a voltage sensor for measuring a state of charge in the high-capacity storage battery 32 and the output type storage battery 34, a current sensor, a temperature sensor, or the like. The determination unit 38 outputs measurement results such as measured voltages, currents, temperatures, and the like to the BMU 36.

The flying object 1 may include a plurality of storage battery units 30. In addition, the storage battery unit 30 may include a plurality of capacity type storage batteries 32 and a plurality of output type storage batteries 34.

For example, the control device 100 is realized by a hardware processor such as a central processing unit (CPU) executing a program (software). Some or all of functions of the control device 100 may be realized by hardware (a circuit; including circuitry) such as a large scale integration (LSI), an application specific integrated circuit (ASIC), a field-programmable gate array (FPGA), or a graphics processing unit (GPU), or may be realized by software and hardware in cooperation. A program may be stored in a storage device (a storage device including a non-transitory storage medium) such as a hard disk drive (a HDD) or a flash memory of the control device 100 in advance or may be stored an attachable/detachable storage medium such as a DVD or a CD-ROM such that the program is installed in the HDD or the flash memory of the control device 100 when a storage medium (a non-transitory storage medium) is mounted in a drive device.

For example, various sensors 120 include a rotation speed sensor, a plurality of temperature sensors, a plurality of pressure sensors, a lubricant sensor, an altitude sensor, a gyrosensor, and the like. The altitude sensor determines the altitude of the flying object 1. The gyrosensor determines the posture of the airframe 10.

The control device 100 controls the electric motors 14, the first control circuits 20, the storage battery unit 30, and the like described above based on operation states thereof or information obtained from the various sensors 120. For example, the control device 100 causes the flying object 1 to take off or land or causes the flying object 1 to fly in a predetermined flight state by controlling each of the functional constitutions described above.

The control device 100 controls the flying object 1 based on flight information. For example, flight information is information obtained from determination results of the various sensors 120 or a flight state of the flying object 1 corresponding to a control signal. When the flight state of the flying object 1 is a first state in which the flying object 1 is cruising, the control device 100 controls the connection unit 33 such that power is supplied from only the high-capacity storage battery 32 of the storage battery unit 30. In addition, when the flight state of the flying object 1 is a second state in which the flying object 1 is taking off or landing, the control device 100 controls the connection unit 33 in accordance with a charge amount of the output type storage battery 34.

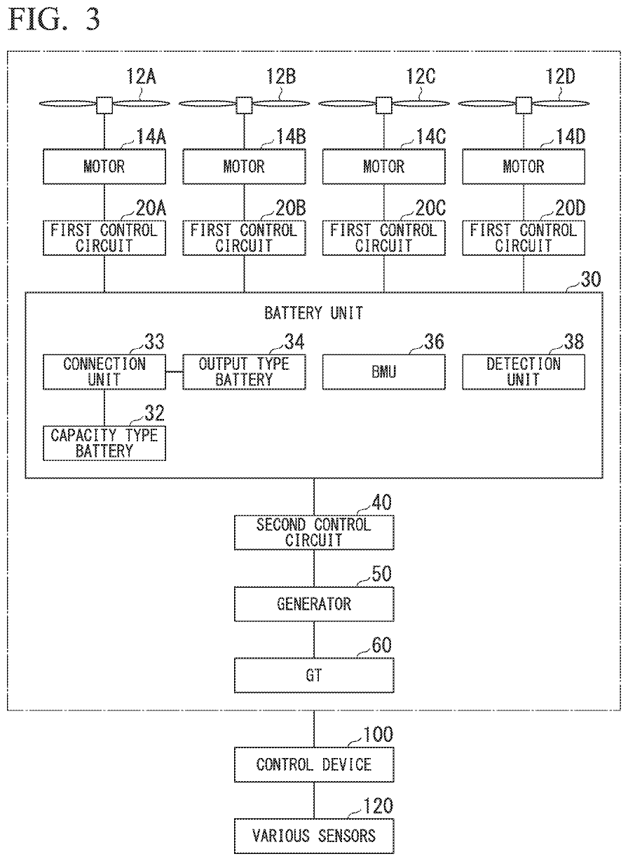

In the flying object 1 shown in FIG. 2, the electric motors 14 are driven by means of power supplied from the storage battery unit 30. FIG. 3 is a view showing another example of a functional constitution of the flying object 1 according to the first embodiment. In addition to those of the flying object 1 shown in FIG. 2, the flying object 1 shown in FIG. 3 includes a second control circuit 40, a generator 50, and a gas turbine engine (which will hereinafter be referred to as “a GT”) 60. As shown in FIG. 3, the flying object 1 includes the generator 50, and the electric motors 14 may be driven by means of power supplied from the storage battery unit and the generator.

The second control circuit 40 is a power conditioning unit (PCU) including a converter and the like. The second control circuit 40 converts AC power generated by the generator 50 into DC power and supplies converted power to the high-capacity storage battery 32, the output type storage battery 34, and/or the first control circuits 20.

The generator 50 is connected to an output shaft of the GT 60. The generator 50 is driven by means of operation of the GT 60, and AC power is generated due to this driving. The generator 50 may be connected to the output shaft of the GT 60 via a deceleration mechanism. The generator 50 functions as a motor. When supply of fuel to the GT 60 is stopped, the GT 60 is caused to rotate (idle) to be in a state in which it can be operated. At this time, the second control circuit 40 performs motoring of the generator 50 by drawing out power from sides of the high-capacity storage battery 32 and the output type storage battery 34. In place of the foregoing functional constitutions, a starter motor may be connected to the output shaft of the GT 60, and the starter motor may cause the GT 60 to be in a state in which it can be operated.

For example, the GT 60 is a turbo-shaft engine. For example, the GT 60 includes an intake port, a compressor, a combustion chamber, a turbine, and the like (not shown). The compressor compresses intake air taken in through the intake port. The combustion chamber is disposed on a downstream side of the compressor and causes mixed gas of compressed air and fuel to combust, thereby generating combustion gas. The turbine is connected to the compressor and integrally rotates with the compressor due to a force of combustion gas. When the output shaft of the turbine rotates due to the foregoing rotation, the generator 50 connected to the output shaft of the turbine operates.

The control device 100 also controls the second control circuit 40, the generator 50, and the GT 60. The rotation speed sensor included in the various sensors 120 determines a rotation speed of the turbine. The temperature sensor determines a temperature in the vicinity of the intake port of the GT 60 or a temperature in the vicinity on a downstream side of the combustion chamber. The pressure sensor determines the pressure inside a container accommodating the control device 100 or the pressure in the vicinity of the intake port of the GT 60. The lubricant sensor determines the temperature of a lubricant supplied to a bearing or the like of the GT 60. Also, in the constitution of FIG. 3, the function of the connection unit 33 is similar to the constitution of FIG. 2.

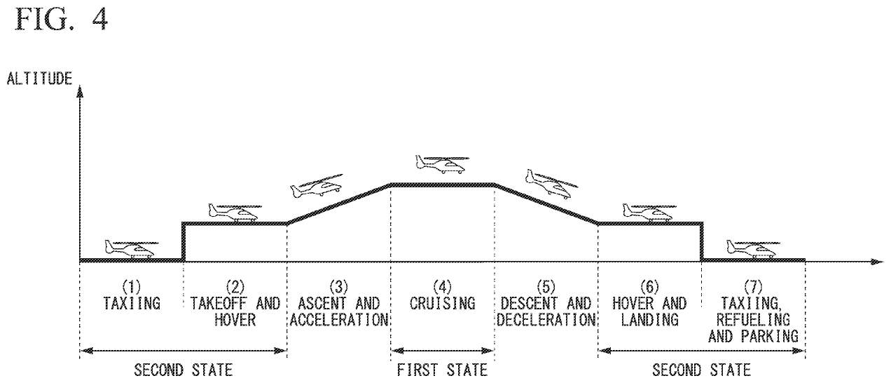

FIG. 4 is an explanatory view of a flight state of the flying object 1 according to the first embodiment. As shown in FIG. 4, the flying object 1 (1) performs taxiing, (2) takes off and hovers (hovering), (3) ascends and accelerates, and (4) cruises. Further, the flying object 1 (5) descends and decelerates, (6) hovers and lands, and (7) performs taxiing, refueling, and parking.

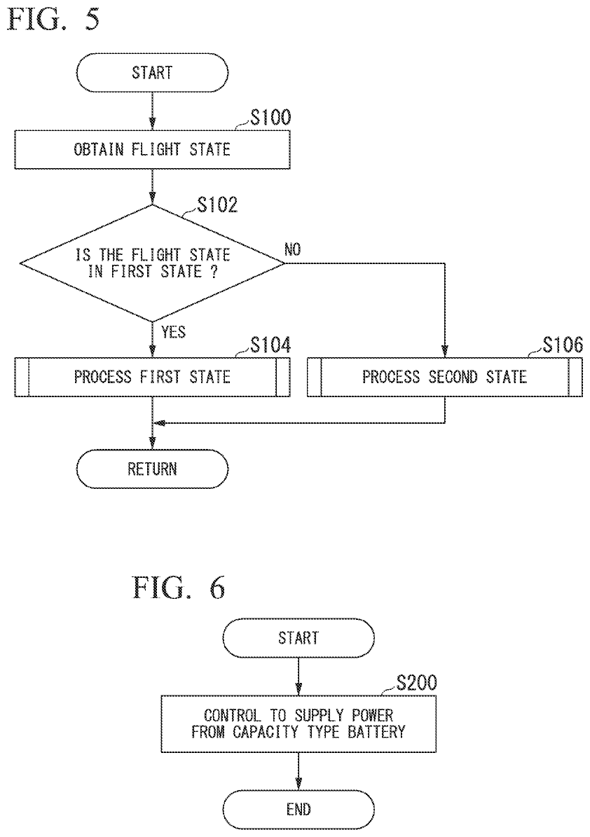

“Cruising” denotes a flight state having a small altitude variation. More specifically, it is a state in which an intentional altitude variation is not performed. “Cruising” is an example of the first state in the claims. In contrast, “taking-off” and “landing” denote a flight state having a larger altitude variation than “cruising” and is an example of the second state in the claims. The second state is also a state having greater power consumption, that is, a larger load than the first state. Other flight states may be defined as states corresponding to the first state, may be defined as states corresponding to the second state, or may be defined as states corresponding to none.

[Flowchart (judgment of flight state)] FIG. 5 is a flowchart showing an example of a flow of processing executed by the control device 100 according to the first embodiment. First, the control device 100 obtains the flight state of the flying object 1 (Step S100). Next, the control device 100 judges whether or not the flight state is the first state (Step S102). When the flight state is the first state, the control device 100 performs processing for the first state (Step S104). In addition, when the flight state is not the first state, the control device 100 performs processing for the second state (Step S106). The processing for the first state and the processing for the second state will be described below. For example, the processing of this flowchart is repeatedly executed in a predetermined cycle.

[Flowchart (First State)]

FIG. 6 is a flowchart showing a flow of processing executed by the control device 100 according to the first embodiment when the flight state is the first state. The control device 100 controls the storage battery unit 30 such that power is supplied from only the high-capacity storage battery 32 (Step S200). The processing performed in Step S200 will be regarded as the processing for the first state.

[Flowchart (Second State)]

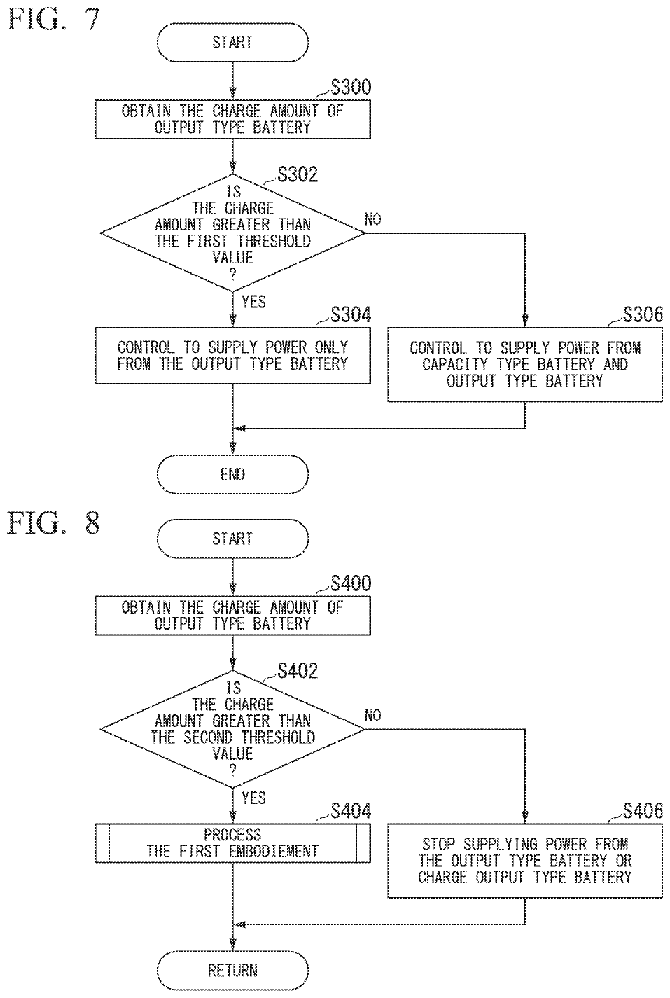

FIG. 7 is a flowchart showing a flow of processing executed by the control device 100 according to the first embodiment when the flight state is the second state. The control device 100 obtains the charge amount of the output type storage battery 34 from the BMU 36 (Step S300). The control device 100 judges whether or not the charge amount of the output type storage battery 34 is equal to or greater than a first threshold (Step S302). For example, the first threshold is a charge amount at which the SOC of the output type storage battery 34 becomes 50%. When the charge amount is equal to or greater than the first threshold, the control device 100 controls the storage battery unit 30 such that power is supplied from only the output type storage battery 34 (Step S304). When the charge amount is equal to or smaller than the first threshold, the control device 100 controls the storage battery unit 30 such that power is supplied from the high-capacity storage battery 32 and the output type storage battery 34 (Step S306). The processing performed in Step S300 to Step S306 will be regarded as the processing for the second state.

As described above, the control device 100 according to the first embodiment suitably uses a different storage battery in accordance with the flight state in which the required quantity of power varies, and thus the expense and the weight of the storage battery can be reduced. In addition, safety at the time of occurrence of a malfunction can be secured by setting a threshold to the charge amount of the output type storage battery and curbing discharging from the output type storage battery 34.

### Second Embodiment

Hereinafter, a second embodiment will be described. In the first embodiment, suitably using a different storage battery is exclusively determined based on the flight state. In contrast, in the second embodiment, suitably using a different storage battery is first determined based on the charge amount of the output type storage battery 34 and then is determined based on the flight state.

FIG. 8 is a flowchart showing an example of a flow of processing executed by the control device 100 according to the second embodiment. First, the control device 100 obtains the charge amount of the output type storage battery 34 from the BMU 36 (Step S400). The control device 100 judges whether or not the charge amount of the output type storage battery 34 is equal to or greater than a second threshold (Step S402). The second threshold is a value smaller than the first threshold in the first embodiment. For example, it is a charge amount at which the SOC of the output type storage battery 34 becomes 25%. When the charge amount is equal to or greater than the second threshold, the processing in the first embodiment is performed (Step S404). The processing in the first embodiment is the processing performed in Step S102 to Step S106. When the charge amount is smaller than the second threshold, the control device 100 controls the storage battery unit 30 such that supply of power from the output type storage battery 34 is stopped or the output type storage battery 34 is charged with power supplied from the generator 50 (Step S406).

In the second embodiment, since the control device 100 obtains the charge amount of the output type storage battery in Step S400, a charging rate may not be obtained in Step S404.

As described above, the control device 100 according to the second embodiment not only exhibits effects similar to those of the first embodiment but can also maintain the charge amount of the output type storage battery 34 at a value equal to or greater than the second threshold and can also enhance reliability of safe landing when the generator or the high-capacity storage battery has malfunctioned.

In addition, the control device 100 can also exhibit the foregoing effects by performing control such that power is not supplied from the output type storage battery 34 during a normal time and performing control such that power is supplied from the output type storage battery 34 only at the time of emergency. At this time, in addition to the foregoing effects, a device for cooling the storage battery can be reduced in size.

### Third Embodiment

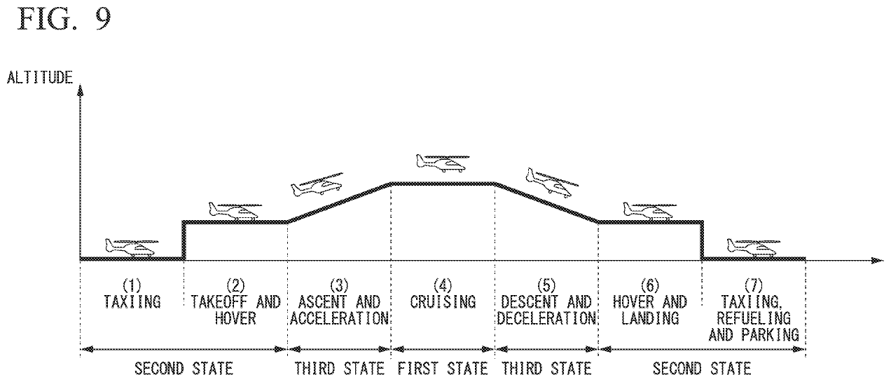

Hereinafter, a third embodiment will be described. In the first embodiment, the control device 100 changes operation when the flight state is the first state or the second state. In contrast, in the third embodiment, the control device 100 changes operation when the flight state is the first state, the second state, or a third state. FIG. 9 is an explanatory view of the flight state of the flying object 1 according to the third embodiment. “Ascending/accelerating”, “descending/decelerating”, and “cruising” are examples of the third state in the claims. The flight state shown in FIG. 9 differs from the flight state in the first embodiment shown in FIG. 4 and is defined as the third state. The third state has greater power consumption than the first state but has smaller power consumption than the second state.

### Flowchart According to Third Embodiment

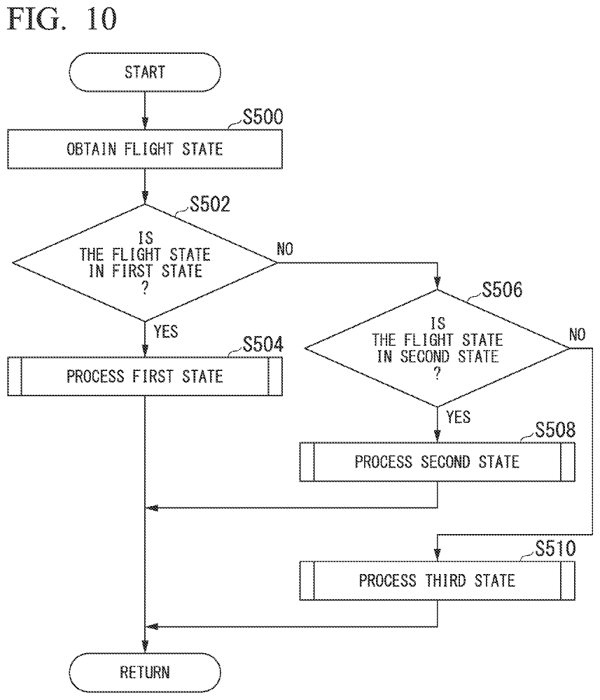

FIG. 10 is a flowchart showing an example of a flow of processing executed by the control device 100 according to the third embodiment. First, the control device 100 obtains the flight state of the flying object 1 (Step S500). Next, the control device 100 judges whether or not the flight state is the first state (Step S502). When the flight state is the first state, the control device 100 performs the processing for the first state (Step S504). In addition, when the flight state is not the first state, the control device 100 judges whether or not the flight state is the second state (Step S506). When the flight state is the second state, the control device 100 performs the processing for the second state (Step S508). When the flight state is not the second state, the control device 100 performs processing for the third state (Step S510). The processing for the first state and the processing for the second state according to the present embodiment are similar to the processing for the first state and the processing for the second state according to the first embodiment. The processing for the third state will be described below. For example, the processing of this flowchart is repeatedly executed in a predetermined cycle.

[Processing for Third State]

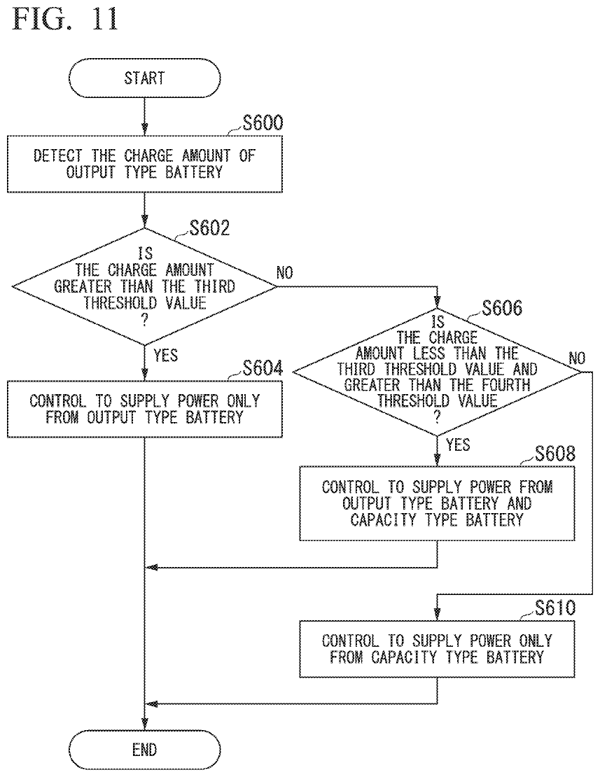

FIG. 11 is a flowchart showing a flow of processing executed by the control device 100 when the flight state is the second state. The control device 100 obtains the charge amount of the output type storage battery 34 from the BMU 36 (Step S600). The control device 100 judges whether or not the charge amount of the output type storage battery 34 is equal to or greater than a third threshold (Step S602). The third threshold is a value greater than the first threshold. For example, it is a charge amount at which the SOC of the output type storage battery 34 becomes 75%. When the charge amount is equal to or greater than the third threshold, the control device 100 controls the storage battery unit 30 such that power is supplied from only the output type storage battery 34 (Step S604).

When the charge amount is equal to or smaller than the third threshold, the control device 100 judges whether or not the charge amount of the output type storage battery 34 is equal to or greater than a fourth threshold (Step S606). The fourth threshold is a value smaller than the first threshold. For example, it is a charge amount at which the SOC of the output type storage battery 34 becomes 25%. When the charge amount is equal to or greater than the fourth threshold, the control device 100 controls the storage battery unit 30 such that power is supplied from the high-capacity storage battery 32 and the output type storage battery 34 (Step S608). When the charge amount is equal to or smaller than the fourth threshold, the control device 100 controls the storage battery unit 30 such that power is supplied from only the high-capacity storage battery 32 (Step S610). The processing performed in Step S600 to Step S610 will be regarded as the processing for the third state.

### Fourth Embodiment

Hereinafter, a fourth embodiment will be described. In the first embodiment to the third embodiment, the control device 100 controls the storage battery unit 30 based on the flight state and the charge amount of the high-capacity storage battery 32. In contrast, in the fourth embodiment, the control device 100 controls the storage battery unit 30 based on whether or not the generator 50 or the high-capacity storage battery 32 has malfunctioned.

In the fourth embodiment, when the generator 50 or the high-capacity storage battery 32 has malfunctioned, the control device 100 controls the storage battery such that power is supplied to the electric motors 14 from the output type storage battery 34. When the generator 50 and the high-capacity storage battery 32 have not malfunctioned, the control device 100 controls the storage battery such that power is not supplied from the output type storage battery 34. Accordingly, the capacity of the output type storage battery 34 can be reduced.

### Fifth Embodiment

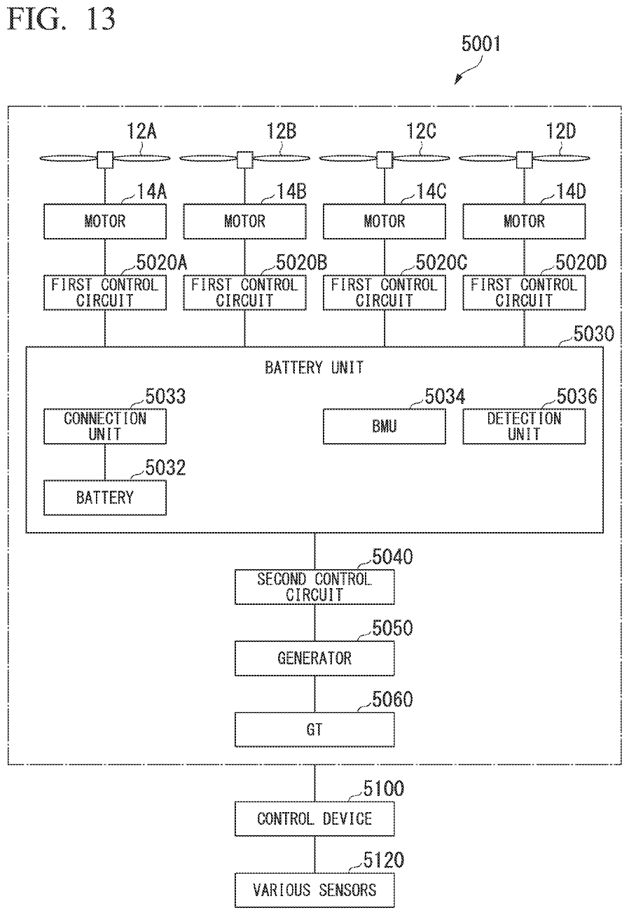

FIG. 13 is a view showing an example of a functional constitution of a flying object 5001 according to a fifth embodiment. For example, in addition to the constitution shown in FIG. 1, the flying object 5001 of the present embodiment includes first control circuits 5020A, 5020B, 5020C, and 5020D, a storage battery unit 5030, a second control circuit 5040, a generator 5050, and a gas turbine engine (which will hereinafter be referred to as “a GT”) 5060. Hereinafter, when the first control circuits 5020A to 5020D are not distinguished from each other, they will be referred to as the first control circuits 5020.

For example, the storage battery unit 5030 includes a storage battery 5032, a battery management unit (BMU) 5034, and a determination unit 5036. For example, the storage battery 5032 is an assembled battery in which a plurality of battery cells are connected in series, in parallel, or in series-parallel. For example, the battery cells constituting the storage battery 5032 are secondary batteries such as lithium-ion batteries (LIB) or nickel-hydride batteries, in which charging and discharging can be repeatedly performed.

A connection unit 5033 is connected to the generator 5050 via the storage battery 5032, the first control circuits 5020, and the second control circuit 5040. The connection unit 5033 is controlled by a control device 5100 such that power is supplied to the first control circuits 5020 selectively from one of or both the storage battery 5032 and the generator 5050. For example, the connection unit 5033 includes a DC-DC converter. Therefore, power is exclusively supplied from the storage battery 5032 to the first control circuits 5020 and power is not supplied from the generator 5050 by boosting an output potential of the storage battery 5032, and power is supplied from the generator 5050 to the first control circuits 5020 by curbing boosting. In addition, the connection unit 5033 may realize a function similar to that described above using a switch, for example.

The BMU 5034 performs cell balancing, determination of an abnormality in the storage battery 5032, derivation of a cell temperature of the storage battery 5032, derivation of a charging/discharging current of the storage battery 5032, estimation of an SOC of the storage battery 5032, and the like. The determination unit 5036 is a voltage sensor for measuring the state of charge in the storage battery 5032, a current sensor, a temperature sensor, or the like. The determination unit 5036 outputs measurement results such as measured voltages, currents, temperatures, and the like to the BMU 5034.

The flying object 5001 may include a plurality of storage battery units 5030. For example, the storage battery units 5030 respectively corresponding to a first constitution and a second constitution may be provided. In the present embodiment, power generated by the generator 5050 is supplied to the storage battery 5032, but the power may be supplied to the first control circuits 5020 and the electric motors 14 without going through the storage battery 5032 (or selectively via the storage battery 5032).

The second control circuit 5040 is a power conditioning unit (PCU) including a converter and the like. The second control circuit 5040 converts AC power generated by the generator 5050 into DC power and supplies converted power to the storage battery 5032 and/or the first control circuits 5020.

The generator 5050 is connected to an output shaft of the GT 5060. The generator 5050 is driven when the GT 5060 operates, and AC power is generated due to this driving. The generator 5050 may be connected to the output shaft of the GT 5060 via a deceleration mechanism. The generator 5050 functions as a motor. When supply of fuel to the GT 5060 is stopped, the GT 5060 is caused to rotate (idle) to be in a state in which it can be operated. At this time, the second control circuit 5040 performs motoring of the generator 5050 by drawing out power from a side of the storage battery 5032. In place of the foregoing functional constitutions, a starter motor may be connected to the output shaft of the GT 5060, and the starter motor may cause the GT 5060 to be in a state in which it can be operated.

For example, the GT 5060 is a turbo-shaft engine. For example, the GT 5060 includes an intake port, a compressor, a combustion chamber, a turbine, and the like (not shown). The compressor compresses intake air taken in through the intake port. The combustion chamber is disposed on a downstream side of the compressor and causes mixed gas of compressed air and fuel to combust, thereby generating combustion gas.

The turbine is connected to the compressor and integrally rotates with the compressor due to a force of combustion gas. When the output shaft of the turbine rotates due to the foregoing rotation, the generator 5050 connected to the output shaft of the turbine operates.

For example, similar to the control device 100 in the first embodiment, the control device 5100 is realized by a hardware processor such as a central processing unit (CPU) executing a program (software).

For example, various sensors 5120 include a rotation speed sensor, a plurality of temperature sensors, a plurality of pressure sensors, a lubricant sensor, an altitude sensor, a gyrosensor, and the like. The rotation speed sensor determines the rotation speed of the turbine. The temperature sensor determines the temperature in the vicinity of the intake port of the GT 5060 or the temperature in the vicinity on a downstream side of the combustion chamber. The lubricant sensor determines the temperature of a lubricant supplied to a bearing or the like of the GT 5060. The pressure sensor determines the pressure inside a container accommodating the control device 5100 or the pressure in the vicinity of the intake port of the GT 5060. The altitude sensor determines the altitude of the flying object 5001. The gyrosensor determines the posture of the airframe 10.

The control device 5100 controls the electric motors 14, the first control circuits 5020, the storage battery unit 5030, the second control circuit 5040, the generator 5050, the GT 5060, and the like described above based on operation state thereof or information obtained from the various sensors 5120. For example, the control device 5100 causes the flying object 5001 to take off or land or causes the flying object 5001 to fly in a predetermined flight state by controlling each of the functional constitutions described above.

The control device 5100 controls the flying object 5001 based on flight information. For example, flight information is information obtained from determination results of the various sensors 5120 or a flight state of the flying object 5001 corresponding to a control signal.

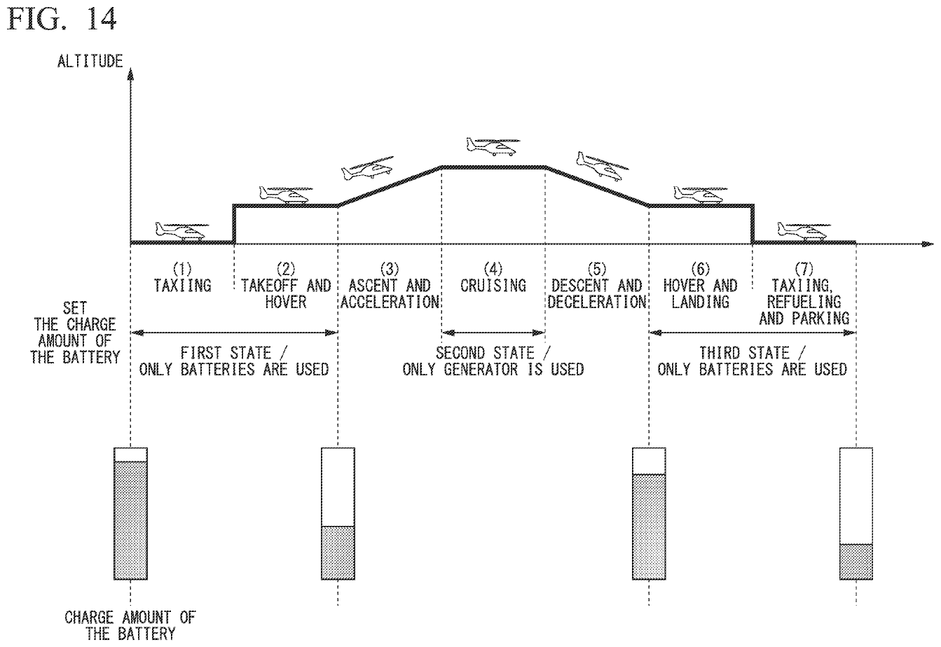

FIG. 14 is an explanatory view of a flight state of the flying object 5001 according to the fifth embodiment. As shown in FIG. 3, the flying object 5001 (1) performs taxiing, (2) takes off and hovers (hovering), (3) ascends and accelerates, and (4) cruises. Further, the flying object 1 (5) descends and decelerates, (6) hovers and lands, and (7) performs taxiing, refueling, and parking. “Taking-off” is an example of the first state in the claims, “cruising” is an example of the second state in the claims, and “landing” is an example of the third state in the claims. “Cruising” denotes a flight state having a small altitude variation. More specifically, it is a state in which an intentional altitude variation is not performed. In contrast, “taking-off” and “landing” denote a flight state having a larger altitude variation than “cruising”. The first state and the third state are states having greater power consumption, that is, a larger load than the second state. Other flight states may be defined as states corresponding to the first state, may be defined as states corresponding to the second state, may be defined as states corresponding to the third state, or may be defined as states corresponding to none.

When the flight state is the first state or the third state, the control device 5100 controls the connection unit 5033 such that power is supplied from only the storage battery 5032. When the flight state is the second state, the control device 5100 controls the connection unit 5033 such that power is supplied from only the generator 5050. For this reason, there is a need for the storage battery 5032 to be charged before the first state by the charge amount to be consumed in the first state and there is a need to be charged before the third state by the charge amount to be consumed in the third state.

The control device 5100 sets the charge amount of the storage battery 5032 before the first state. This charge amount is an amount determined based on conditions such as a scheduled period for the first state. In the storage battery 5032, when the first state ends, this charge amount decreases to a charge amount within a first charging range. For example, the first charging range denotes a range in which the SOC of the storage battery 5032 is within 5% to 10%.

Moreover, in the second state, the electric motors 14 are driven by means of power supplied from only the generator 5050. In addition, the storage battery 5032 is charged by means of power supplied from the generator 5050. The charge amount required in the second state is set such that the charge amount of the storage battery 5032 becomes a charge amount within a second charging range when the third state ends. For example, the second charging range denotes a range in which the SOC of the storage battery 5032 is within 3% to 7%.

[Flowchart (Control During Flight)]

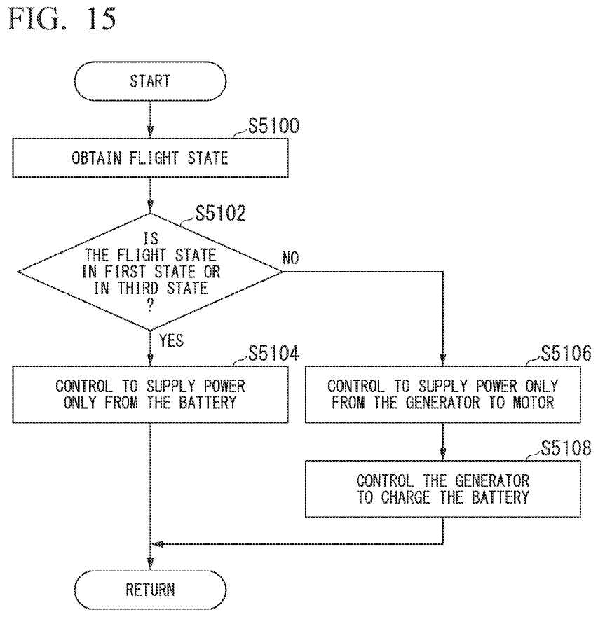

FIG. 15 is a flowchart showing an example of a flow of processing executed by the control device 5100 according to the fifth embodiment. First, the control device 5100 obtains the flight state of the flying object 5001 (Step S5100). Next, the control device 5100 judges whether or not the flight state is the first state or the third state (Step S5102). When the flight state is the first state or the third state, the control device 5100 controls the connection unit 5033 such that power is supplied from only the storage battery 5032 to the electric motors 14 (Step S5104). When the flight state is neither the first state nor the third state, namely, when the flight state is the second state, the control device 5100 controls the connection unit 5033 such that power is supplied from only the generator 5050 to the electric motors 14 (Step S5106). In addition, the control device 5100 controls the connection unit 5033 such that the storage battery 5032 is charged with power supplied by the generator 5050 (Step S5108). For example, the processing of this flowchart is repeatedly executed in a predetermined cycle.

After the flying object 5001 has landed, the storage battery 5032 can be charged using an external power source or the generator 5050. After charging is completed, the flying object 5001 can take off and fly again.

As described above, the flying object 5001 according to the first embodiment need only be mounted with storage batteries required for the first state and the third state, and thus weight reduction of the flying object 5001 and increase in payload can be achieved.

### Sixth Embodiment

Hereinafter, a sixth embodiment will be described. In the fifth embodiment, power is supplied from only the storage battery when the flight state is the first state or the third state. In contrast, in the sixth embodiment, power is supplied from the storage battery and the generator when the flight state is the first state or the third state. Constitutions similar to those in the fifth embodiment may be described using reference signs similar to those in the fifth embodiment.

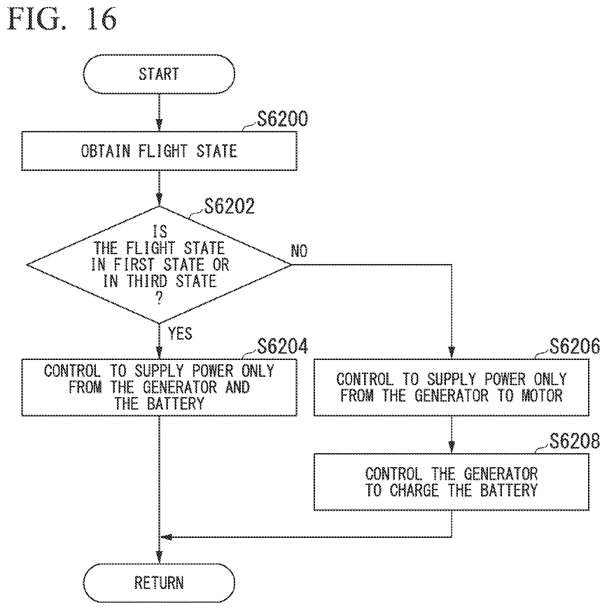

FIG. 16 is a flowchart showing an example of a flow of processing executed by the control device 5100 according to the sixth embodiment.

First, the control device 5100 obtains the flight state of the flying object 5001 (Step S6200). Next, the control device 5100 judges whether or not the flight state is the first state or the third state (Step S6202). When the flight state is the first state or the third state, the control device 5100 controls the connection unit 5033 such that power is supplied from the generator 5050 and the storage battery 5032 to the electric motors 14 (Step S6204). When the flight state is neither the first state nor the third state, namely, when the flight state is the second state, the control device 5100 controls the connection unit 5033 such that power is supplied from only the generator 5050 to the electric motors 14 (Step S6206). In addition, the control device 5100 controls the connection unit 5033 such that the storage battery 5032 is charged with power supplied by the generator 5050 (Step S6208). For example, the processing of this flowchart is repeatedly executed in a predetermined cycle.

As described above, the flying object 5001 according to the sixth embodiment differs from the flying object 5001 according to the fifth embodiment so that the storage battery can be further reduced in weight by using the generator 5050 in the first state and the third state as well.

[Method of Manufacturing Aircraft]

Hereinafter, a method of manufacturing an aircraft utilizing the propulsion system for an aircraft described above will be described. In this manufacturing method, the ratio between the numbers of storage battery cells mounted in an aircraft is determined based on the flight state of a flight scheduled for the aircraft. For example, in a case of a flight in the long first state, the ratio of the number of output type storage battery cells to the number of high-capacity storage battery cells is determined as a small ratio. In a case of a flight in the long second state, the ratio of the number of output type storage battery cells to the number of high-capacity storage battery cells is determined as a large ratio.

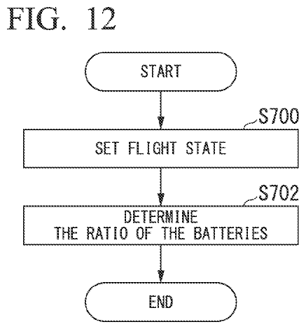

FIG. 12 is a flowchart showing a method of manufacturing an aircraft. First, the flight state is set (Step S700). Thereafter, the ratio between the numbers of storage battery cells is determined based on the set flight state (Step S702). Regarding determining the ratio between the numbers of storage battery cells, determination is performed based on the method of using the output type storage battery and the high-capacity storage battery according to the first to third embodiments. Accordingly, an aircraft can be favorably manufactured.

Hereinabove, forms for performing the present invention have been described using the embodiments, but the present invention is not limited to such embodiments in any way, and various modifications and replacements can be applied within a range not departing from the gist of the present invention.

For example, in the fifth embodiment and the sixth embodiment, the lower limit for the first charging range and the second charging range may be set to a value at which the SOC of the storage battery 5032 becomes 0%. Accordingly, there is no need for the charge amount of the storage battery 5032 to remain at the ends of the first state and the third state, and thus the storage battery can be further reduced in weight.

When the generator 5050 can be used, the control device 5100 may control the connection unit 5033 such that only the generator 5050 supplies power to the electric motors. When the generator 5050 cannot be used, the connection unit 5033 may be controlled such that only the storage battery 5032 supplies power to the electric motors 14. In addition, the charge amount of the storage battery 5032 may be set such that the storage battery 5032 retains a charge amount equal to or greater than the third threshold after landing when the generator 5050 cannot be used. For example, the third threshold is a charge amount at which the SOC of the storage battery 5032 becomes 5%.

Accordingly, the storage battery 5032 can be minimized. In addition, since the storage battery 5032 is used only when the generator 5050 cannot be used, there is no need to provide a cooling system.

### EXPLANATION OF REFERENCES

1, 5001 Flying object
10 Airframe
12 Rotor
14 Electric motor
16 Arm
20, 5020 First control circuit
32 High-capacity storage battery
34 Output type storage battery
36, 5034 Battery management unit (BMU)
38, 5036 Determination unit
40, 5040 Second control circuit
50, 5050 Generator
60, 5060 Gas turbine engine (GT)
100, 5100 Control device
120, 5120 Various sensors
5030 Storage battery unit
5032 Storage battery

What is claimed is:

1. A propulsion system for an aircraft mounted in an airframe of an aircraft, the propulsion system comprising:
a first storage battery;
a second storage battery that has a smaller capacity and more power able to be output per hour than the first storage battery;
a charge amount determination unit that determines at least a state of charge in the second storage battery;
an electric motor that is driven by means of power supplied from the first storage battery or the second storage battery;
a rotor that is driven by means of a driving force output by the electric motor; and
a control unit that controls power supplied from the first storage battery or the second storage battery to the electric motor by controlling a connection unit connecting the first storage battery or the second storage battery and the electric motor to each other,
wherein the control unit
controls the connection unit such that power is exclusively supplied from the first storage battery to the electric motor when a flight state of the aircraft is a first state,
controls the connection unit such that power is exclusively supplied from the second storage battery to the electric motor when the flight state of the aircraft is a second state having a larger altitude variation than the first state and the state of charge in the second storage battery is a state having a degree of charge higher than a first reference, and
controls the connection unit such that power is supplied from both the first storage battery and the second storage battery to the electric motor when the flight state of the aircraft is the second state and the state of charge in the second storage battery is a state having a degree of charge lower than the first reference.

2. The propulsion system for an aircraft according to claim 1 further comprising:
an engine that is attached to the airframe of the aircraft; and
a generator that is connected to an engine shaft of the engine,
wherein the first storage battery and the second storage battery store power generated by the generator, and
wherein the electric motor is driven by means of power supplied from the first storage battery, the second storage battery, or the generator.

3. The propulsion system for an aircraft according to claim 1,
wherein the control unit controls the connection unit such that supply of power from the second storage battery to the electric motor is stopped when the state of charge in the second storage battery is a state having a degree of charge lower than a second reference, and
wherein the second reference is a reference indicating a lower charging rate or a lower charge amount than the first reference.

4. The propulsion system for an aircraft according to claim 2,
wherein the control unit controls the connection unit such that power generated by the generator is supplied to the second storage battery when the state of charge in the second storage battery is a state having a degree of charge lower than the second reference, and
wherein the second reference is a reference indicating a lower charging rate or a lower charge amount than the first reference.

5. The propulsion system for an aircraft according to claim 1,
wherein the control unit
controls the connection unit such that power is exclusively supplied from the second storage battery to the electric motor when the flight state is a third state and the state of charge in the second storage battery is a state having a degree of charge higher than a third reference,
controls the connection unit such that power is supplied from both the first storage battery and the second storage battery to the electric motor when the flight state is the third state and the state of charge in the second storage battery has a degree of charge lower than the third reference and has a degree of charge higher than a fourth reference, and
controls the connection unit such that power is exclusively supplied from the first storage battery to the electric motor when the flight state is the third state and when the state of charge in the second storage battery has a degree of charge lower than the fourth reference, and
wherein the third state has a larger altitude variation than the first state and has a smaller altitude variation than the second state.

6. A propulsion system for an aircraft mounted in an airframe of an aircraft, the propulsion system comprising:
an engine that is attached to the airframe of the aircraft;
a generator that is connected to an engine shaft of the engine;
a first storage battery;
a second storage battery that has a smaller capacity and more power able to be output per hour than the first storage battery;
an electric motor that is driven by means of power supplied from the first storage battery, the second storage battery, or the generator;
a rotor that is driven by means of a driving force output by the electric motor; and
a control unit that controls power supplied from the first storage battery or the second storage battery to the electric motor by controlling a connection unit connecting the first storage battery or the second storage battery and the electric motor to each other, and
wherein the control unit controls the connection unit such that power is supplied from the second storage battery to the electric motor when the generator or the first storage battery has malfunctioned.

7. A propulsion system for an aircraft comprising:
an engine that is attached to an airframe of the aircraft;
a generator that is connected to an engine shaft of the engine;
a storage battery that is charged with power generated by the generator;
a charge amount determination unit that determines a state of charge in the storage battery;
an electric motor that is driven by means of power supplied from the generator and the storage battery;
a rotor that is driven by means of a driving force output by the electric motor; and
a control unit that controls power supplied from the storage battery to the electric motor by controlling a connection unit connecting the storage battery and the electric motor to each other,
wherein when a flight state of the aircraft changes from a first state to a third state via a second state, the control unit
sets a charge amount of the storage battery before the first state such that the state of charge in the storage battery at a point of time when the first state ends is within a first charging range,
controls the connection unit such that power is exclusively supplied from the storage battery to the electric motor while the flight state is the first state,
controls the connection unit such that power is exclusively supplied from the generator to the electric motor while the flight state is the second state,
controls the connection unit such that power generated by the generator is supplied to the storage battery such that the charge amount of the storage battery at a point of time when the third state ends is within a second charging range while the flight state is the second state, and
controls the connection unit such that power is exclusively supplied from the storage battery to the electric motor while the flight state is the third state, and
wherein the second state is a state having a smaller altitude variation than the first state and the third state.

8. A propulsion system for an aircraft comprising:
an engine that is attached to an airframe of the aircraft;
a generator that is connected to an engine shaft of the engine;
a storage battery that is charged with power generated by the generator;
a charge amount determination unit that determines a state of charge in the storage battery;
an electric motor that is driven by means of power supplied from the generator and the storage battery;
a rotor that is driven by means of a driving force output by the electric motor; and
a control unit that controls power supplied from the storage battery to the electric motor by controlling a connection unit connecting the storage battery and the electric motor to each other,
wherein when a flight state of the aircraft changes from a first state to a third state via a second state, the control unit
sets a charge amount of the storage battery before the first state such that the state of charge in the storage battery at a point of time when the first state ends is within a first charging range,
controls the connection unit such that power is supplied from the generator and the storage battery to the electric motor while the flight state is the first state,
controls the connection unit such that power is exclusively supplied from the generator to the electric motor while the flight state is the second state,
controls the connection unit such that power generated by the generator is supplied to the storage battery such that the charge amount of the storage battery at a point of time when the third state ends is within a second charging range while the flight state is the second state, and
controls the connection unit such that power is supplied from the generator and the storage battery to the electric motor while the flight state is the third state, and
wherein the second state is a state having a smaller altitude variation than the first state and the third state.

9. The propulsion system for an aircraft according to claim 7,
wherein a lower limit for both the first charging range and the second charging range is zero.

10. The propulsion system for an aircraft according to claim 8,
wherein a lower limit for both the first charging range and the second charging range is zero.

11. The propulsion system for an aircraft according to claim 7,
wherein before the aircraft takes off, the storage battery is charged with power supplied from a ground external power source or power generated by the generator up to the set charge amount.

12. The propulsion system for an aircraft according to claim 8,
wherein before the aircraft takes off, the storage battery is charged with power supplied from a ground external power source or power generated by the generator up to the set charge amount.

13. A propulsion system for an aircraft comprising:
an engine that is attached to an airframe of the aircraft;
a generator that is connected to an engine shaft of the engine;
a storage battery that is charged with power generated by the generator;
a charge amount determination unit that determines a state of charge in the storage battery;
an electric motor that is driven by means of power supplied from the generator and the storage battery;
a rotor that is driven by means of a driving force output by the electric motor; and
a control unit that controls power supplied from the storage battery to the electric motor by controlling a connection unit connecting the storage battery and the electric motor to each other,
wherein the control unit
controls the connection unit such that power is exclusively supplied from the generator to the electric motor when the generator is able to be used, and
controls the connection unit such that power is supplied from only the storage battery to the electric motor when the generator is not able to be used, and
wherein a charge amount of the storage battery is set such that a charge amount equal to or greater than a third threshold is retained when the aircraft lands.

14. A method of manufacturing an aircraft using the propulsion system for an aircraft according to claim 1,
wherein a ratio between the numbers of output type storage battery cells and high-capacity storage battery cells mounted in the aircraft is determined based on a state during flight.
